(19) United States
(12) Patent Application Publication
(10) Pub. No.: US 2003/0093545 A1
(43) Pub. Date: May 15, 2003

(54) Method and system for downloading data to portable electronic device

(75) Inventors: Hsiang-Min Liu, Taipei (TW); Shih-Li Wen, Taipei (TW)

Correspondence Address: EDWARDS & ANGELL, LLP, 101 Federal Street, Boston, MA, 02110, US

(73) Assignee: Inventec Tomorrow Work Studio Corporation, Taiwan

(21) Appl. No.: 09/993,785

(22) Filed: Nov. 14, 2001

(51) Int. Cl. G06F 15/16

(52) U.S. Cl. 709/231; 709/229

(57) ABSTRACT

A method and a system for downloading data to a portable electronic device are proposed, which enable a terminal user to login a service management center through wired network connection established by e.g. a computer device, or through wireless communication by using e.g. a WAP cellular phone. This allows the terminal user to manage personal book data and browse introduction information of books, as well as to download required books in a charge manner. Moreover, such a downloading mechanism makes the terminal user to be able to freely download required data, and obtain latest information of newly published books as accompanied in the downloading process; this indirectly reduces costs in advertisement of the new books. Therefore, the foregoing downloading method and system are advantageous of allowing a user to read desired data at any time, and also providing commercial benefits as to save costs for printing, storing, selling and advertising conventional paper-made books.

### FIELD OF THE INVENTION

The present invention relates to methods and systems for downloading data to portable electronic devices, and more particularly, to a method and a system for downloading data to a portable electronic device, in which a terminal user with a portable electronic device can download required data through wireless network communication.

### BACKGROUND OF THE INVENTION

With rapid development in computer and Internet technology, people now are able to enjoy a more efficient and simplified mode of communication, for example, to send or receive mails, check stock market information, take on-line commercial activities, check time and schedule, and watch the live news through a network. In particular, for downloading a book from a website through the use of network connection, such a book is displayed in the form of an electronic book (e-book), which is more advantageous than a conventional paper-printed book for being able to contain more data and information. However, this data retrieval method is limited due to network access not available everywhere for people to download required data. Therefore, a type of small-scale and portable reader is now commercially available for use in reading e-books.

However, development of e-book technology has not filly succeeded, and available content of e-books and memory of e-book readers are both restricted so as not to be able to provide all required data for users, thereby making the provision of e-book readers eventually not an optimal way for convenient data retrieval.

In addition, due to rapid development of wireless communication, the global population of cellular phone users is increasing exponentially. This makes the wireless communication become a very potential market, and provision of fashionable and attractive service for the cellular phone users is accordingly an important subject. In a present GSM system, generally, the cellular phone users are only provided with short message service (SMS) to send and receive short messages, but not able to download large size data such as e-books through the use of cellular phones.

Therefore, how to allow a user with a portable device to browse and download a large amount of data as required in real time, is a critical problem to solve.

### SUMMARY OF THE INVENTION

A primary objective of the present invention is to provide a method and a system for downloading data to a portable electronic device, in which a terminal user can download e-books immediately through a network in a convenient and rapid data retrieval manner.

Another objective of the invention is to provide a method and a system for downloading data to a portable electronic device, in which a terminal user can unlimitedly download required data through the use of wireless network communication.

In accord with the above and other objectives, the present invention proposes a method and a system for downloading data to a portable electronic device. In the method for downloading data to a portable electronic device of the invention, a data source management center integrates data provided by publishers or authors, and informs a service management center to retrieve the data for allowing a user to download and browse the data by using a portable electronic device; the method comprises the steps of (1) converting the data via the data source management center into electronic files, and encoding the electronic files to be stored in a file database of the data source management center; (2) transmitting the encoded electronic files via the data source management center through a network to the service management center, and storing the encoded electronic files via the service management center in a file database thereof: (3) determining via the service management center if the user with the portable electronic device submits a request for downloading an electronic file, wherein if the downloading request is submitted, the service management center determines if the user is an authorized member thereof, and step (4) is proceeded; if no downloading request is received by the service management center, the step (3) is returned; (4) inquiring the user via the service management center to register for membership if the user is not an authorized member; retrieving a corresponding encoded electronic file for downloading as requested by the user from the file database via the service management center, and transmitting the retrieved electronic file to the portable electronic device if the user is an authorized member; (5) dividing the retrieved encoded electronic file into sections via the service management center; (6) placing the sections of the divided encoded electronic file in a dividing order into a temporary storing region of the service management center in a stack form; (7) retrieving the sections of the divided encoded electronic file via the service management center from the temporary storing region in a first-in-first-out manner, and converting the file sections into displayable format of the portable electronic device, so as to transmit the file sections to the portable electronic device, wherein the portable electronic device stores the received file sections in sequence in a download storing region; (8) determining via the service management center if the sections of the electronic file are completely transmitted, wherein if the transmission is complete, then step (9) is proceeded; or else, the step (7) is returned; (9) establishing a record of bill data via the service management center for charging communication time spent for downloading the electronic file by using the portable electronic device, and storing the bill data in a bill database of the service management center to be used as reference for charging the user with the portable electronic device; and (10) decoding the encoded electronic file in the download storing region via a decoding module of the portable electronic device, for allowing the user to read the decoded electronic file.

The system for downloading data to a portable electronic device of the invention comprises: a data source management center for receiving data through a network and converting the data into electronic files that are encoded and stored in a file database of the data source management center; a service management center for transmitting the encoded electronic files from the file database of the data source management center to a file database of the service management center, and for establishing a record of member data to be stored in a member database thereof, so as to verify if a user who submits a login request is a member of the service management center, and allow the user to download required electronic files from the service management center if the user is verified with membership, wherein the service management center constructs a record of dedicated personal file data for the user, to be browsed by the user for introduction and latest information of electronic file in the personal file data, allowing the user to delete or retain the information if necessary; and at least one user who is connected through a network to the service management center by using a computer device, wherein after the use is permitted to login the service management center, a corresponding record of dedicated personal file data is transmitted to the user for browsing; the user is able to be wirelessly connected to the service management center by using a portable electronic device, and after the use is verified as a member of the service management center, a corresponding record of dedicated personal file data is transmitted to the portable electronic device, allowing the user to browse introduction information of electronic files in the personal file data for selection; after the user submits a request for downloading a selected electronic file, the service management center searches from the file database for a corresponding encoded electronic file, and divides the searched encoded electronic file into sections to be transmitted to the portable electronic device, allowing a decoding module of the portable electronic device to decode the transmitted encoded electronic file, and the user to browse and read the decoded electronic file.

In the use of the method and system for downloading data to a portable electronic device of the invention, a user needs to register in a service management center to be a member, and then can freely and conveniently use a portable electronic device to generate a wireless connection signal to the service management center, so as to download required data at any time. This therefore provides a simple and immediate mechanism for data reading, and is advantageous of saving costs for printing, selling, advertising, transporting and storing conventional paper-made books. As a result, the invention not only allows the user to retrieve desired book information in real time, but also makes authors or publishers realize public interest and acceptable situation of books in the form of electronic documents.

### BRIEF DESCRIPTION OF THE DRAWINGS

The present invention can be more filly understood by reading the following detailed description of the preferred embodiments, with reference made to the accompanying drawings, wherein:

FIG. 1 is a schematic block diagram showing basic architecture of a system for downloading data to a portable electronic device of the invention;

FIG. 2 a schematic diagram depicting a method for downloading data to a portable electronic device of the invention in the use of a computer device to login a service management center; and

FIG. 3 a schematic diagram depicting a method for downloading data to a portable electronic device of the invention in the use of a portable electronic device to login a service management center.

### DETAILED DESCRIPTION OF THE PREFERRED EMBODIMENTS

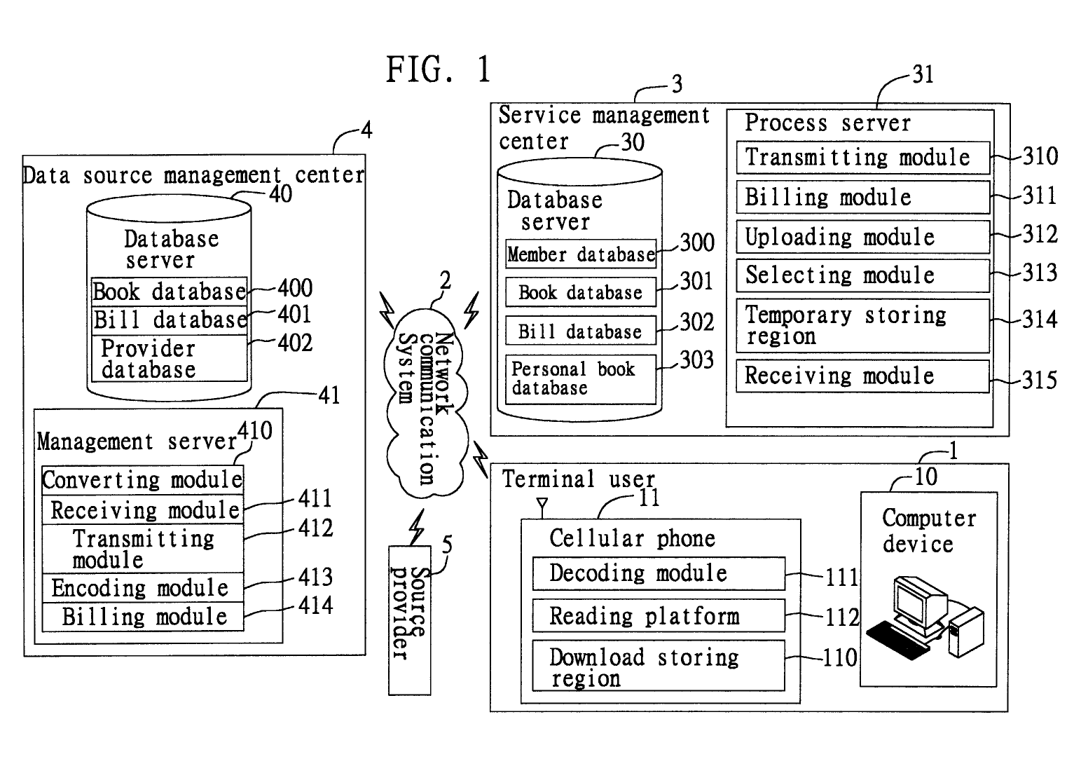

Referring to FIG. 1, it illustrates a system for downloading data to a portable electronic device of the invention. The downloading system is used to connect a terminal user 1 through a network communication system 2 to a service management center 3, allowing the terminal user 1 to search desired book information or a personal book database established in the service management center 3. In particular, in the use of the downloading system, the terminal user 1 with a cellular phone 11 can be wirelessly connected through the network communication system 2 to the service management center 3, so as to use the cellular phone 11 to download an electronic book (e-book) from the service management center 3. This makes data in Internet able to be retrieved by using the cellular phone 11. Therefore, even in the case of the terminal user 1 not at a fixed location, data in the World Wide Web can be browsed and obtained through the use of the downloading system; this brings much convenience for data retrieval.

The network communication system 2 includes a network system, e.g. a wireless network equipped with multiple signal reception stations, Internet, etc. The Internet interconnects web page servers at different locations, such as the service management center 3 and a data source management center 4. This allows the terminal user 1 at the computer device 10 to be linked up with a web page server such as the service management center 3. Further, the wireless network makes the terminal user 1 with the cellular phone 11 send a message in an operation mode of wireless application protocol (WAP) through the signal reception station to a WAP gateway, where the message from the cellular phone 11 in the form of wireless markup language (WML) is converted into conventional HTTP to be transmitted to the service management center 3, so as to prompt the service management center 3 to operate according to the received message (described in detail as follows). As the Internet and WAP systems are well known to those skilled in the art, detailed functions and internal architecture pertained thereto are not be further described herein. It should be noted that, in this embodiment, an e-book downloaded by the terminal user 1, and the cellular phone 11 used to establish communication between the terminal user 1 and the service management center 3, are exemplified; however, this does not confine the invention to these examples in practice. Alternatively, downloaded data can be other information such as pictures, images, sounds and so on, and a portable electronic device used for communication establishment can be e.g. a notebook computer, personal digital assistant (PDA), etc. Besides, the wireless transmission protocol between the portable device and the service management center 3 is not limited to WAP.

As shown in the drawing, the data source management center 4 comprises: a database server 40 including a book database 400, a bill database 401 and a provider database 402; and a management server 41 including a converting module 410, a receiving module 411, an uploading module 412, an encoding module 413 and a billing module 414. The service management center 3 comprises: a database server 30 including a member database 300, a book database 301, a bill database 302 and a personal book database 303; and a process server 31 including a transmitting module 310, a billing module 311, an uploading module 312, a selecting module 313, a temporary storing region 314 and a receiving module 315.

The data source management center 4 receives information and data from a source provider 5 through the network communication system 2, wherein the source provider 5 can be a book dealer, author and various other commercial entities. The source provider 5 uploads edited books or other document files in formats such as WORD and TXT to the data source management center 4 through the network communication system 2. The receiving module 411 receives the uploaded files attached with other information associated with the provider, such as the provider's name, address, contact numbers and e-mail address and so on, and all these data are stored in the provider database 402. In the meantime, the converting module 410 converts the uploaded files into e-book files in formats such as OEBF and EBX. Then, these e-book files are encoded by the encoding module 413, and stored in the book database 400, so as to avoid unauthorized retrieval of the stored the encoded files. Next, the uploading module 412 uploads the encoded e-book files to the service management center 3.

After the service management center 3 receives the encoded e-book files from the data source management center 4, the receiving module 315 is prompted to store the encoded files in the book database 301. This allows the terminal user 1 with authorization to immediately retrieve required book information in a manner that, the terminal user 1 firstly browses book content information stored in the personal book database 303 by using the computer device 10, and then uses the cellular phone 11 to download a desired e-book file for being displayed on a screen of the cellular phone 11.

Prior to loginning the service management center 3 for e-book file downloading, the terminal user 1 needs to register in the service management center 3 to become an authorized member. To do so, the terminal user 1 uses the computer device 10 to link up with the service management center 3 through a network, and submits a request of registration. In response, the terminal user 1 is asked to input associated personal information for registration, such as a login account, an identification number (ID) and a communication number of the cellular phone 11. After completing the registration, the service management center 3 stores the personal information in the member database 300, and allows the terminal user 1 to access the service management center 3 through the use of the computer device 10 or the cellular phone 11. In typical operation, the terminal user 1 uses the computer device 10 to establish wired network connection with the service management center 3, and submits a request for browsing book content. The service management center 3 constructs dedicated personal book data for each of its authorized members, and stores the personal book data in the personal book database 303. Such personal book data provide function selections, such as introduction information of newly published books and a list of available books, wherein the personal book data can be renewed by the encoded e-book files uploaded from the data source management center 4. In other words, for example, the new book information can be updated by the uploaded e-book files, so as to allow the terminal user 1 to realize the latest information of newly published books; this therefore facilitates book advertising effect and reduces costs in advertisement. Moreover, the terminal user 1 can process information deletion or retaining of the new books through the use of the selecting module 313. On the other hand, the list of available books includes downloaded and undownloaded book names, and acts as reference for the terminal user 1 to consider if to download the undownloaded books to the cellular phone 11.

After the terminal user 1 obtains authorization and browses the corresponding person book data in the service management center 3, a book downloading process now can be activated for the terminal user 1 by using the cellular phone 11. As such, the cellular phone 11 is preformed with a connection control key (not shown) to automatically establish wireless connection between the cellular phone 11 and the service management center 3, allowing the terminal user 1 to download e-book files to the cellular phone 11 for browsing. In operation, first, when the terminal user 1 clicks the connection control key, the service management center 3 receives a wireless transmission signal from the cellular phone 11, and search in the member database 300 for a record of member information corresponding in communication number to the wireless transmission signal. If such corresponding member information is available, it indicates the terminal user 1 is an authorized member, and the service management center 3 retrieves corresponding personal book data from the personal book database 303, and the transmitting module 310 converts the retrieved personal book data into format displayable on a screen (not shown) of the cellular phone 11, for example, converting HTML format used for Internet into WML format for wireless transmission. The retrieved personal book data displayed on the cellular phone 11 act as reference considered for the terminal user 1 in data downloading.

Accordingly, when the terminal user 1 select a book displayed on the cellular phone 11 for downloading, the transmitting module 310 is prompted to search in the book database 301 for an encoded e-book file corresponding to the selection of the terminal user 1. Then, the searched encoded e-book file is properly divided according to transmission bandwidth provided by the network communication system 2, and the divided sections of the encoded e-book file are in turn stacked and placed in the temporary storing region 314. Subsequently, the transmitting module 310 converts the divided file sections into displayable format of the cellular phone 11, and transmits the divisions of the encoded e-book file in sequence.

Next, the cellular phone 11 receives the divisions of the encoded e-book file in a stack manner, and in turn places them into a download storing region 110 thereof. For reading, a decoding module 111 retrieves the divisions of the encoded e-book file from the download storing region 110 in sequence and decodes the divided e-book file. Then, a reading platform 112 displays the decoded e-book file in a customized manner set by the terminal user 1 on the cellular phone 11, for example, the e-book file can be displayed with automatic page turning, or with provision of a control key for page turning.

Since the download storing region 110 of the cellular phone 11 only stores encoded e-book files, and the cellular phone 11 is provided with its dedicated decoding module 111 (for example, the decoding module 111 corresponds to a communication number dedicated for the terminal user 1), thus it does not allow the terminal user 1 to interact with other terminal users for downloaded e-book files through the use of cellular phones. This therefore effectively assures the paying for data downloading, and secures the rights of book authors and the service management center 3. Such characteristics makes the invention more advantageous, whereas the current data downloading process through Internet is not valid in securing downloading authorization and fee charge.

Moreover, after the transmitting module 310 completes transmission of the divided e-book file, the billing module 311 establishes a record of bill data for charging the communication time spent for downloading e-books in the use of the cellular phone 11, and stores the bill data in the bill database 302. The bill data includes fees of network communication and data downloading to be paid by the terminal user 1 to the service management center 3, and is used as invoice to periodically (e.g. monthly) charge the terminal user 1. On the other hand, after storing the bill data in the bill database 302, the billing module 311 shares the payment from the terminal user 1 in a percentage manner that, for example, 80% of the payment is assigned to the data source management center 4. Then, a record of firstly shared bill data is accordingly generated and uploaded by the uploading module 312 to the data source management center 4, for being stored in the bill database 401. Upon receiving the firstly shared bill data, the data source management center 4 prompts the billing module 414 to conduct second payment share; that is, a portion in percentage of the payment left after the foregoing first share is assigned to the source provider 5. This generates a record of secondly shared bill data, which is stored in the bill database 401, and acts as invoice for paying the source provider 5. It should be noted that, besides communication and downloading fees, each record of bill data also contains associated data of the downloaded book, e.g. book title, author, or publisher. Accordingly, the data source management center 4 can retrieve corresponding information of the source provider 5 (such as living address, e-mail address, etc) from the provider database 402 according to the author or publisher recorded in the bill data, so as to inform the author or publisher of an income offering.

In addition, besides the process server shown in FIG. 1, the service management center 3 may also include multiple process servers 31 having the same functions, and a system monitoring server (not shown) for monitoring the data flow of each process server 31. As a result, if a process server 31 is over loaded, the system monitoring server can assign another process server 31 to share the load, when there are getting more terminal users 1 to login the service management center 3.

Therefore, the system for downloading data to a portable electronic device of the invention, not only enables a terminal user to read e-books at any time, but also provides a precise mechanism for effectively charging data downloading, as well as allows book authors or publishers to realize public interest and reaction to published e-books.

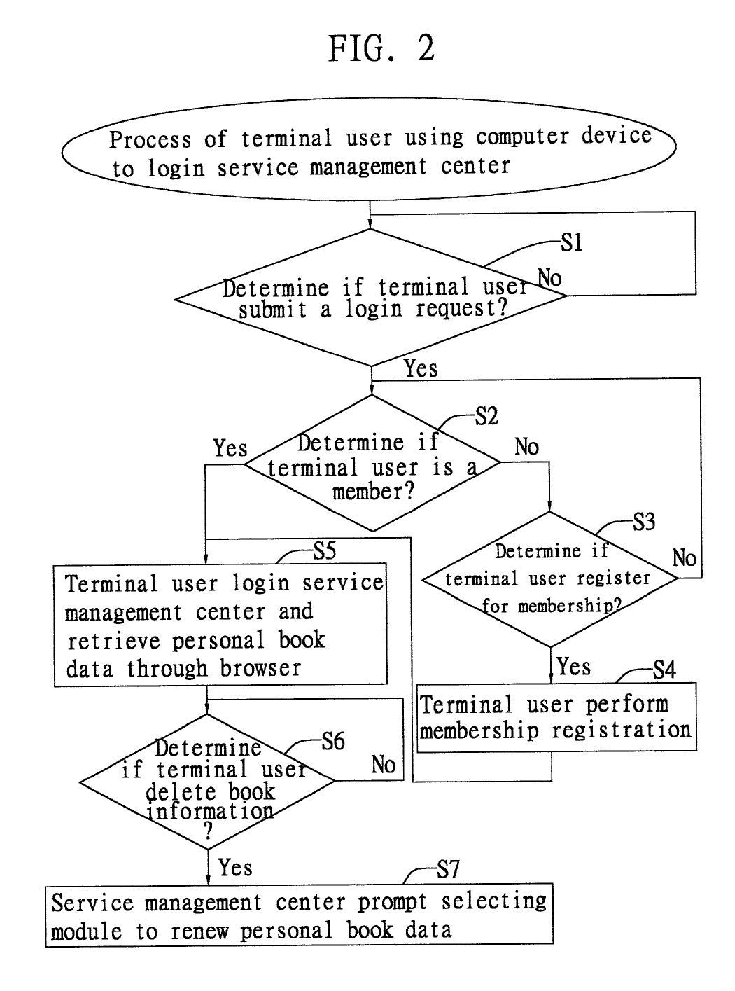

Referring to FIG. 2, it illustrates a method for downloading data to a portable electronic device of the invention in the use of a computer device 10 for a terminal user 1 to login a service management center 3. The following description is made with reference to FIGS. 1 and 2.

First, the terminal user 1 uses the computer device 10 to establish network connection to the service management center 3. Then, in step S1, the service management center 3 determines if the terminal user 1 submits a login request. If the login request is submitted, then step S2 is proceeded; or else, the step S1 is returned.

In step S2, the service management center 3 asks the terminal user 1 to input a login account and identification number, and verifies validity of the terminal user 1 by comparing the inputted data with member data stored in a member database 300. If the inputted data are verified to match a record of the member data, then step S5 is proceeded; or else, step S3 is proceeded.

In step S3, the service management center 3 determines if the terminal user 1 desires to apply for member registration. If the member registration is applied, then step S4 is proceeded; or else, the step S2 is returned.

In step S4, the terminal user 1 follows a registration process provided by the service management center 3, and accordingly inputs a login account, identification number and communication number. After the registration process is completed, the service management center 3 establishes a dedicated record of member data to be stored in the member database 300. Thereafter, step S5 is proceeded.

In step S5, the service management center 3 allows the terminal user 1 to login and browse dedicated personal book data through a browser (not shown) of the computer device 10, so as to retrieve introduction information of books. Thereafter, step S6 is proceeded.

In step S6, the service management center 3 determines if the terminal user 1 deletes the introduction information of books. If information deletion is performed, then step S7 is proceeded; or else, the step S6 is returned.

In step S7, the service management center 3 prompts a selecting module 313 to renew the personal book data, and store the renewed book data in a personal book database 303.

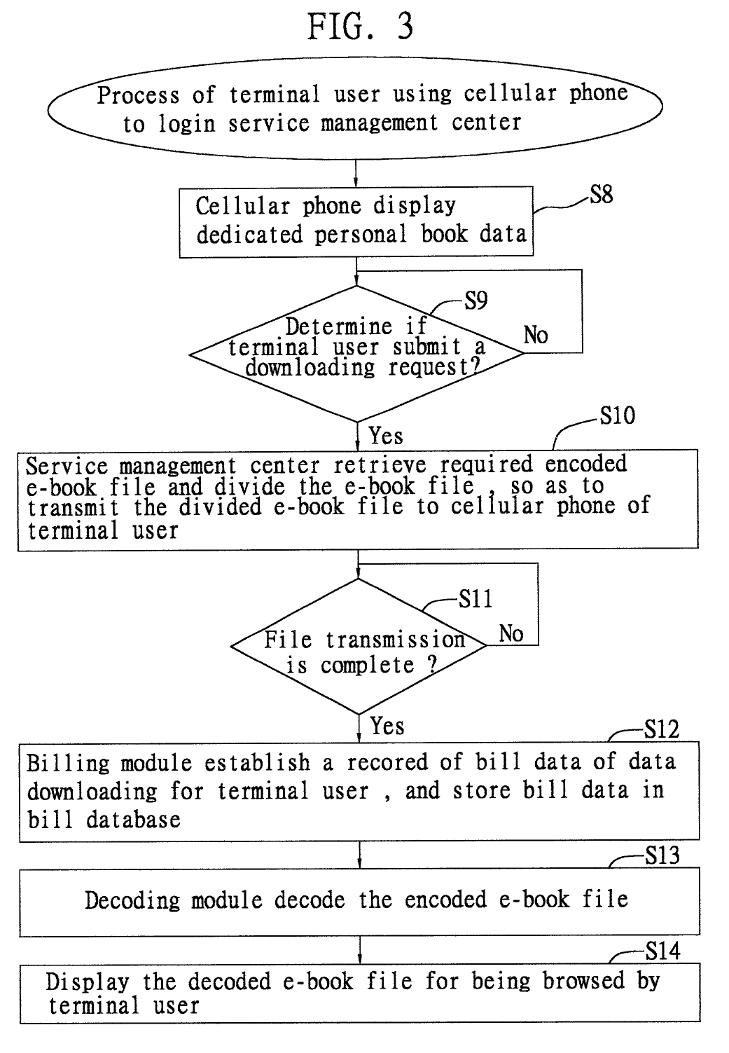

Referring to FIG. 3, it illustrates a method for downloading data to a portable electronic device of the invention in the use of a cellular phone 11 for a terminal user 1 to login a service management center 3. The following description is made with reference to FIGS. 1 and 3.

First, the terminal user 1 uses the cellular phone 11 to establish wireless network connection to the service management center 3, which then searches in a member database 300 for a record of member data corresponding in communication number to a wireless signal from the cellular phone 11. Then, in step S8, the service management center 3 retrieves corresponding personal book data from a personal book database 303 according to the searched member data. A transmitting module 310 is prompted to convert the retrieved personal book data into displayable format of the cellular phone 11, so as to allow the terminal user 1 to browse and decide books for downloading. Thereafter, step S9 is proceeded.

In step S9, the service management center 3 determines if the terminal user 1 submits a downloading request. If the downloading request is submitted, then step S10 is proceeded; or else, the step S9 is returned.

In step S10, the service management center 3 retrieves an encoded e-book file for downloading from a book database 301 in response to the terminal user 1's request, and divides the retrieved encoded e-book file, wherein the divisions of the encoded e-book file are stacked in sequence and placed in a temporary storing region 314. Then, the transmitting module 310 converts the divided e-book file into displayable format of the cellular phone 11, and transmits the divisions of the encoded e-book file in an first-in-first-out order from the temporary storing region 314 to a download storing region of the cellular phone 11. Thereafter, step S11 is proceeded.

In step S11, the service management center 3 determines if the transmitting module 310 completes transmission of the divided e-book file. If the transmission is complete, then step S12 is proceeded; or else, the step S11 is returned.

In the step S12, the service management center 3 prompts a billing module 311 to generate a record of bill data for charging communication time spent for downloading e-books in the use of the cellular phone 11, and store the bill data in a bill database 302. Thereafter, step S13 is proceeded.

In step S13, the cellular phone 11 receives the divisions of the encoded e-book file in sequence and stored them in the download storing region 110 in the form of stacks. When the terminal user 1 desires to browse the e-book file, a decoding module 111 is prompted to retrieve the divisions of the encoded e-book file from the download storing region 110 for decoding them in the first-in-first-out order. Thereafter, step S14 is proceeded.

In step S14, the decoded e-book file is displayed visually on a reading platform 112 of the cellular phone 11 for being browsed by the terminal user 1.

In conclusion, the method and system for downloading data to a portable electronic device of the invention enable a terminal user to login a service management center through wired network connection established by e.g. a computer device, or through wireless communication by using e.g. a WAP cellular phone. This allows the terminal user to manage personal book data and browse introduction information of books, as well as to download required books in a charge manner. Moreover, such a downloading mechanism makes the terminal user to be able to freely download required data, and obtain latest information of newly published books as accompanied in the downloading process; this indirectly reduces costs in advertisement of the new books. Therefore, the invention is advantageous of allowing a user to read desired data at any time, and also providing commercial benefits as to save costs for printing, storing, selling and advertising conventional paper-made books.

While the invention has been described in conjunction with a specific best mode, it is to be understood that many alternatives, modifications, and variations will be apparent to those skilled in the art in light of the a foregoing description. Accordingly, it is intended to embrace all such alternatives, modifications, and variations which fall within the spirit and scope of the included claims. All matters set forth herein or shown in the accompanying drawings are to be interpreted in an illustrative and non-limiting sense.

What is claimed is:

1. A method for downloading data to a portable electronic device, in which a data source management center integrates data provided by publishers or authors, and informs a service management center to retrieve the data for allowing a user to download and browse the data by using a portable electronic device; the method comprising the steps of:
(1) converting the data via the data source management center into electronic files, and transmitting the electronic files to the service management center, wherein the transmitted electronic files are stored in a file database of the service management center;
(2) determining via the service management center if the user with the portable electronic device submits a request for downloading an electronic file, wherein if the downloading request is submitted, the service management center determines if the user is an authorized member thereof, and step (3) is proceeded; if no downloading request is received by the service management center, the step (2) is returned; and
(3) inquiring the user via the service management center to register for membership if the user is not an authorized member; retrieving a corresponding electronic file for downloading as requested by the user from the file database via the service management center, and transmitting the retrieved electronic file to the portable electronic device if the user is an authorized member.

2. The method of claim 1, wherein in the step (1), prior to transmitting the electronic files to the service management center, the electronic files are encoded so as to avoid unauthorized retrieval of the electronic files.

3. The method of claim 2, wherein after the service management center retrieves the encoded electronic file for downloading from the file database, the step (3) further comprises the steps of:
(3-1) dividing the retrieved encoded electronic file into sections via the service management center;
(3-2) placing the sections of the divided encoded electronic file in a dividing order into a temporary storing region of the service management center in a stack form; and
(3-3) retrieving the sections of the divided encoded electronic file via the service management center from the temporary storing region in a first-in-first-out manner, and converting the file sections into displayable format of the portable electronic device, so as to transmit the file sections to the portable electronic device, wherein the portable electronic device stores the received file sections in sequence in a download storing region, allowing the user to browse the electronic file.

4. The method of claim 3, wherein the step (3-3) further comprises the steps of:
(3-3-1) determining via the service management center if the sections of the electronic file are completely transmitted, wherein if the transmission is complete, then step (3-3-2) is proceeded; or else, the step (3-3-1) is returned; and
(3-3-2) establishing a record of bill data via the service management center for charging communication time spent for downloading the electronic file by using the portable electronic device, and storing the bill data in a bill database of the service management center to be used as invoice reference for charging the user with the portable electronic device.

5. A method for downloading data to a portable electronic device, in which a data source management center integrates data provided by publishers or authors, and informs a service management center to retrieve the data for allowing a user to download and browse the data by using a portable electronic device; the method comprising the steps of:
(1) converting the data via the data source management center into electronic files, and encoding the electronic files to be stored in a file database of the data source management center;
(2) transmitting the encoded electronic files via the data source management center through a network to the service management center, and storing the encoded electronic files via the service management center in a file database thereof;
(3) determining via the service management center if the user with the portable electronic device submits a request for downloading an electronic file, wherein if the downloading request is submitted, the service management center determines if the user is an authorized member thereof, and step (4) is proceeded; if no downloading request is received by the service management center, the step (3) is returned;
(4) inquiring the user via the service management center to register for membership if the user is not an authorized member; retrieving a corresponding encoded electronic file for downloading as requested by the user from the file database via the service management center, and transmitting the retrieved electronic file to the portable electronic device if the user is an authorized member;
(5) dividing the retrieved encoded electronic file into sections via the service management center;
(6) placing the sections of the divided encoded electronic file in a dividing order into a temporary storing region of the service management center in a stack form;
(7) retrieving the sections of the divided encoded electronic file via the service management center from the temporary storing region in a first-in-first-out manner, and converting the file sections into displayable format of the portable electronic device, so as to transmit the file sections to the portable electronic device, wherein the portable electronic device stores the received file sections in sequence in a download storing region;
(8) determining via the service management center if the sections of the electronic file are completely transmitted, wherein if the transmission is complete, then step (9) is proceeded; or else, the step (7) is returned;
(9) establishing a record of bill data via the service management center for charging communication time spent for downloading the electronic file by using the portable electronic device, and storing the bill data in a bill database of the service management center to be used as reference for charging the user with the portable electronic device; and
(10) decoding the encoded electronic file in the download storing region via a decoding module of the portable electronic device, for allowing the user to read the decoded electronic file.

6. The method of claim 5, wherein in the step (9), after storing the established record of bill data in the bill database, the service management center performs a first payment sharing process, so as to assign a portion of payment from the user to the data source management center, and generate a record of firstly shared bill data to be uploaded to the data source management center, for being used as reference of payment from the service management center to the data source management center.

7. The method of claim 6, wherein after receiving the firstly shared bill data, the data source management center performs a second sharing process for the received firstly shared bill data in a manner that, a portion of payment left after completing the first sharing process is assigned to a source provider, and a record of secondly shared bill data is generated to be stored in a bill database of the data source management center, for being used as reference of payment to the source provider.

8. The method of claim 5, wherein the service management center periodically retrieves the bill data from the bill database thereof to balance a bill statement, that is e-mailed through a network to a network post server for allowing the user to receive the bill statement through network connection established by a computer device to the network post server, or that is transmitted in a form of a wireless communication short message to a message center for allowing the user to receive the bill statement through wireless connection established by the portable electronic device to the message center.

9. The method of claim 5, wherein the portable electronic device is internally formed with a reading platform for retrieving the electronic file downloaded from the service management center, so as to display content of the retrieved electronic file on the portable electronic device for being browsed and read by the user.

10. A method for downloading data to a portable electronic device, in which a data source management center integrates data provided by publishers or authors, and informs a service management center to retrieve the data for allowing a user to download and browse the data by using a portable electronic device; the method comprising the steps of:
(1) converting the data via the data source management center into electronic files, and encoding the electronic files to be stored in a file database of the data source management center;
(2) transmitting the encoded electronic files via the data source management center through a network to the service management center, and storing the encoded electronic files via the service management center in a file database thereof;
(3) informing the user through a network to register membership in the service management center, wherein the user inputs associated data of a login account, an identification number and a communication number; establishing a record of member data according to the inputted associated data, and storing the member data in a member database of the service management center;
(4) determining via the service management center if the user with the portable electronic device submits a request for downloading an electronic file, wherein if the downloading request is submitted, the service management center determines if the user is an authorized member thereof, and step (5) is proceeded; if no downloading request is received by the service management center, the step (4) is returned;
(5) retrieving a corresponding encoded electronic file for downloading as requested by the user from the file database via the service management center, and dividing the retrieved encoded electronic file into sections;
(6) placing the sections of the divided encoded electronic file in a dividing order into a temporary storing region of the service management center in a stack form;
(7) retrieving the sections of the divided encoded electronic file via the service management center from the temporary storing region in a first-in-first-out manner, and converting the file sections into displayable format of the portable electronic device, so as to transmit the file sections to the portable electronic device, wherein the portable electronic device stores the received file sections in sequence in a download storing region;
(8) determining via the service management center if the sections of the electronic file are completely transmitted, wherein if the transmission is complete, then step (9) is proceeded; or else, the step (7) is returned;
(9) establishing a record of bill data via the service management center for charging communication time spent for downloading the electronic file by using the portable electronic device, and storing the bill data in a bill database of the service management center to be used as reference for charging the user with the portable electronic device;
(10) performing a first payment sharing process via the service management center to assign a portion of payment from the user to the data source management center, and generating a record of firstly shared bill data to be uploaded to the data source management center, for being used as reference of payment from the service management center to the data source management center;
(11) performing a second sharing process for the received firstly shared bill data via the data source management center in a manner that, a portion of payment left after completing the first sharing process is assigned to a source provider, and generating a record of secondly shared bill data to be stored in a bill database of the data source management center, for being used as reference of payment to the source provider; and
(12) decoding the encoded electronic file in the download storing region via a decoding module of the portable electronic device, for allowing the user to read the decoded electronic file.

11. A system for downloading data to a portable electronic device, comprising:
a data source and service management center for receiving data and converting the data into electronic files to be stored in a file database of the data source and service management center, and for establishing a record of member data including a login account, an identification number and a communication number for a user who firstly logins the data source and service management center, so as to construct a record of dedicated personal file data corresponding to the record of the member data, for being browsed by the user; and
at least one user who is wirelessly connected to the data source and service management center by using a portable electronic device, wherein after the use is verified as a member of the data source and service management center, a corresponding record of dedicated personal file data is transmitted to the portable electronic device, allowing the user to browse introduction information of electronic files in the personal file data; after the user submits a request for downloading a selected electronic file, the data source and service management center searches from the file database for a corresponding electronic file, and transmits the searched electronic file to the portable electronic device, for allowing the user to browse and read the transmitted electronic file.

12. A system for downloading data to a portable electronic device, comprising:
a data source and service management center for receiving data and converting the data into electronic files that are encoded and stored in a file database of the data source and service management center, and for establishing a record of member data to be stored in a member database, so as to verify if a user who submits a login request is a member of the data source and service management center, and allow the user to download required electronic files from the data source and service management center if the user is verified with membership, wherein the data source and service management center constructs a record of dedicated personal file data for the user, to be browsed by the user for introduction and latest information of electronic file in the personal file data, allowing the user to delete or retain the information if necessary; and
at least one user who is connected through a network to the data source and service management center by using a computer device, wherein after the use is permitted to login the data source and service management center, a corresponding record of dedicated personal file data is transmitted to the user for browsing; the user is able to be wirelessly connected to the data source and service management center by using a portable electronic device, and after the use is verified as a member of the data source and service management center, a corresponding record of dedicated personal file data is transmitted to the portable electronic device, allowing the user to browse introduction information of electronic files in the personal file data for selection; after the user submits a request for downloading a selected electronic file, the data source and service management center searches from the file database for a corresponding encoded electronic file, and divides the searched encoded electronic file into sections to be transmitted to the portable electronic device, allowing a decoding module of the portable electronic device to decode the transmitted encoded electronic file, and the user to browse and read the decoded electronic file.

13. A system for downloading data to a portable electronic device, comprising:
a data source management center for receiving data through a network and converting the data into electronic files that are encoded and stored in a file database of the data source management center;
a service management center for transmitting the encoded electronic files from the file database of the data source management center to a file database of the service management center, and for establishing a record of member data to be stored in a member database thereof, so as to verify if a user who submits a login request is a member of the service management center, and allow the user to download required electronic files from the service management center if the user is verified with membership, wherein the service management center constructs a record of dedicated personal file data for the user, to be browsed by the user for introduction and latest information of electronic file in the personal file data, allowing the user to delete or retain the information if necessary; and
at least one user who is connected through a network to the service management center by using a computer device, wherein after the use is permitted to login the service management center, a corresponding record of dedicated personal file data is transmitted to the user for browsing; the user is able to be wirelessly connected to the service management center by using a portable electronic device, and after the use is verified as a member of the service management center, a corresponding record of dedicated personal file data is transmitted to the portable electronic device, allowing the user to browse introduction information of electronic files in the personal file data for selection; after the user submits a request for downloading a selected electronic file, the service management center searches from the file database for a corresponding encoded electronic file, and divides the searched encoded electronic file into sections to be transmitted to the portable electronic device, allowing a decoding module of the portable electronic device to decode the transmitted encoded electronic file, and the user to browse and read the decoded electronic file.

14. The system of claim 13, wherein the member data stored in the member database of the service management center include a login account, an identification number and a communication number inputted by the user, and are used as reference for the service management center to verify identity of a user who submits a login request.

15. The system of claim 13, wherein the service management center has a bill database, for storing a record of bill data established by the service management center for charging a process of transmitting the encoded electronic file to the user by the service management center, and the bill data are used as invoice reference for charging the user.

16. The system of claim 15, wherein the service management center periodically retrieves the bill data from the bill database thereof to balance a bill statement, that is e-mailed through a network to a network post server for allowing the user to receive the bill statement through network connection established by the computer device to the network post server, or that is transmitted in a form of a wireless communication short message to a message center for allowing the user to receive the bill statement through wireless connection established by the portable electronic device to the message center.

17. The system of claim 15, wherein after storing the bill data in the bill database, the service management center performs a first payment sharing process, so as to assign a portion of payment from the user to the data source management center, and generate a record of firstly shared bill data to be uploaded to the data source management center, for being used as reference of payment from the service management center to the data source management center.

18. The system of claim 17, wherein after receiving the firstly shared bill data, the data source management center performs a second sharing process for the received firstly shared bill data in a manner that, a portion of payment left after completing the first sharing process is assigned to a source provider, and a record of secondly shared bill data is generated to be stored in a bill database of the data source management center, for being used as reference of payment to the source provider.

19. The system of claim 18, wherein the secondly shared bill data stored in the bill database of the data source management center include fees of online communication and data downloading paid by the service management center to the data source management center, and fees of online communication and data downloading paid by the data source management center to the source provider.

20. A system for downloading data to a portable electronic device, comprising:
a data source management center for receiving data through a network from a source provider and transmitting the data to a service management center; the data source management center including a receiving module for receiving the data from the source provider; a converting module for converting the received data into electronic files that are encoded and stored in a file database of the data source management center; an encoding module for encoding the electronic files; a file database for storing the encoded electronic files; a transmitting module for transmitting the encoded electronic files to the service management center; a billing module for performing a payment sharing process for bill data transmitted from the service management center, and accordingly generating a record of shared bill data to be used as reference of payment to the source provider; a bill database for storing the shared bill data generated by the billing module; and a provider database for storing basic information of the source provider, so as to transmit the shared bill data to the source provider according to a living address or an email address of the source provider recorded in the basic information thereof;
a service management center for receiving the encoded electronic files from the data source management center, allowing a user who is a member of the service management center to download the encoded electronic files; the service management center including a receiving module for receiving the encoded electronic files from the data source management center; a file database for storing the received encoded electronic files; a member database for storing a record of member data established by the service management center according to a login account, an identification number and a communication number inputted by the user who registers in the service management center, wherein the member data are used as reference for user's identity identification; a personal file database for storing a record of dedicated personal file data established according to the member data of the user, wherein the personal file data are browsed by the user for introduction and latest information of electronic file after the user logins the service management center, allowing the user to delete or retain the information if necessary; a selecting module for allowing the user to browse introduction information of electronic files in the personal file data for selection, and searching from the file database for a corresponding encoded electronic file after the user with a portable electronic device submits a request for downloading a selected electronic file; a transmitting module for dividing the searched encoded electronic file into sections and converting the file sections into displayable format of the portable electronic device, so as to transmit the file sections in sequence to the portable electronic device; a billing module for establishing a record of bill data for charging the user by the service management center; and a bill database for storing the bill data established by the billing module, wherein the bill database is also transmitted by the transmitting module to the data source management center for performing the payment sharing process; and
a user who is connected through a network to the service management center by using a computer device, wherein after the use is permitted to login the service management center, a corresponding record of dedicated personal file data is transmitted to the user for browsing; the user is able to be wirelessly connected to the service management center by using a portable electronic device, and after the use is verified as a member of the service management center, a corresponding record of dedicated personal file data is transmitted to the portable electronic device, allowing the user to browse introduction information of electronic files in the personal file data for selection; after the user submits a request for downloading a selected electronic file, the service management center searches from the file database for a corresponding encoded electronic file, and divides the searched encoded electronic file into sections to be transmitted to the portable electronic device; the portable electronic device includes a temporary storing region for storing the encoded electronic file transmitted from the service management center; a decoding module for decoding the encoded electronic file stored in the temporary storing region; and a reading platform for allowing the user to browse the decoded electronic file displayed on the portable electronic device.
